(19) United States
(12) Patent Application Publication
(10) Pub. No.: US 2010/0264560 A1
(43) Pub. Date: Oct. 21, 2010

(54) IMPRINT LITHOGRAPHY APPARATUS AND METHOD

(76) Inventor: Zhuqing Zhang, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/746,738

(22) PCT Filed: Dec. 19, 2007
(86) PCT No.: PCT/US2007/088250

§ 371 Date: Jun. 7, 2010

(51) Int. Cl. B29C 33/42; B28B 11/08

(52) U.S. Cl. 264/220; 425/385

(57) ABSTRACT

An imprint lithography stamp (101, 201, 401, 501, 617) includes a base layer (301, 619); a functional layer (303, 621) of lithography features (307, 309, 403, 405, 503, 505) protruding from the base layer (301, 619); and a support layer (305, 623) comprising a regular pattern of sub-features (311, 313, 407, 409, 507, 509, 613, 615, 625) protruding from the lithography features (307, 309, 403, 405, 503, 505). An imprint lithography system (100, 200, 300) includes a substrate (104, 205, 513, 601) having a layer of resin material (511) deposited thereon; a stamp (101, 201, 401, 501, 617) having a base layer (301, 619), a functional layer (303, 621) of lithography features (307, 309, 403, 405, 503, 505) protruding from the base layer (301, 619) and a support layer (305, 623) comprising a regular pattern of sub-features (311, 313, 407, 409, 507, 509, 613, 615, 625) protruding from the lithography features (307, 309, 403, 405, 503, 505); and an imprinting device configured to press the stamp (101, 201, 401, 501, 617) into the resin material (511).

### BACKGROUND

Using imprint lithography, very small scale electrical features or circuit elements may be fabricated on a substrate. The imprint lithography process involves the creation of patterns on a substrate by mechanically deforming a resin layer deposited on the substrate with a patterned stamp. The resulting patterns stamped into the resin layer are then used to form the desired electrical features or circuit elements on the substrate.

Two main types of imprint lithography include thermal imprinting and ultraviolet imprinting. In thermal imprinting, a thermal plastic resin is heated above its glass transition temperature, and the stamp is then pressed into the molten resin under high pressure. In ultraviolet (UV) imprinting, a pliable, resin layer of photo-sensitive monomers is embossed with the lithography stamp and then cured with exposure to UV light during or after the stamping process.

An imprint lithography stamp is typically made of hard, durable material that contains nano- or micro-scale features defined thereon. These features are then used to emboss a desired pattern into a deposited resin layer on a substrate under controlled conditions as noted above.

The resin layer is typically very thin and has portions that are compressed by the imprint of the features on the lithography stamp. These compressed portions of the resin layer are then referred to as a compressed layer. After stamping, selective etch is used to remove the compressed layer portion of the resin layer. The substrate under the imprint features is therefore exposed for further processing.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1A-1D show cross-sectional views of consecutive steps in an illustrative imprint lithography process, according to principles described herein.

FIGS. 2A-2C show cross-sectional views of consecutive steps in an illustrative imprint lithography process, according to principles described herein.

FIG. 3 shows a cross-sectional view of an illustrative imprint lithography stamp apparatus, according to principles described herein.

FIGS. 4A-4C are bottom view depictions of illustrative imprint lithography stamp apparatus having different types of support layers, according to principles described herein.

FIGS. 5A-5C show cross-sectional views of consecutive steps in an illustrative imprint lithography process, according to principles described herein.

FIGS. 6A-6F show cross-sectional views of consecutive steps in an illustrative imprint lithography stamp fabrication process, according to principles described herein.

FIG. 7 is a bottom view of an illustrative imprint lithography stamp fabricated using the process shown in FIG. 6, according to principles described herein.

FIG. 8 is a flowchart of an illustrative method of imprint lithography stamp fabrication, according to principles described herein.

Throughout the drawings, identical reference numbers designate similar, but not necessarily identical, elements.

### DETAILED DESCRIPTION

As described above, imprint lithography typically uses a hard stamp that contains nano- or micro-scale features defined thereon to emboss a desired pattern into a resin layer on a substrate. The resulting thickness contrasts in the resin layer may then be transferred to the substrate through a controlled etching process

The imprint lithography has been successfully employed in nano-scale and micro-scale patterning. However, an issue is presented when the stamp includes features of both a relatively small and large scale. Particularly, some imprint lithography stamps may need to simultaneously imprint large-scale features (e.g., features measured in hundreds of microns or larger) and small-scale features (e.g. features measured in a few microns or in nanometers). Where a large-scale feature is being imprinted into the resin layer, a larger volume of the resin layer receiving the imprint is displaced or compressed as compared with an area of the resin layer where small or smaller-scale features are being imprinted.

Due to the difference in feature density and therefore the difference in resin displacement by the features, the resulting compressed layer may be much thicker where large-scale features have been formed than where small-scale features have been formed. An example of this will be illustrated and described below. In such cases, it requires longer etching time to eliminate the thicker compressed layer corresponding to large-scale imprinted features. This makes it difficult to obtain a uniform etch depth in the underlying substrate for both large- and small-scale features.

One prior solution for dealing with non-uniform compressed layer thickness is to mask the area with the thinner compressed layer material during etching so that the etching eventually results in a uniform etch depth for all features in the underlying substrate. This approach, however, requires a separate etch mask for each imprint pattern and can be difficult and costly to implement in a full-scale manufacturing process.

Another prior solution involves placing venting holes within the larger features of an imprint mask. However, this requires the imprint resin to flow into these venting holes to replace the air inside of the venting holes. The replaced air may create bubbles in the resin which may result in defects or even shorts in the circuitry.

To address these issues, the present specification describes new methods and devices for imprint lithography that promote a uniform thickness of a compressed resin layer beneath both large and small scale imprint features. The systems and methods of the present specification describe various embodiments of an imprint lithography stamp having a base layer, a functional layer of lithography features deposited on the base layer, and a support layer having a regular pattern of sub-features deposited on and extending only from the lithography features.

As used in the present specification and in the appended claims, the term “compressed layer” refers to a thin layer of compressed resin patterned by stamp features in an imprint lithography stamp.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative apparatus and methods of imprint lithography.

### Illustrative Imprint Lithography Device

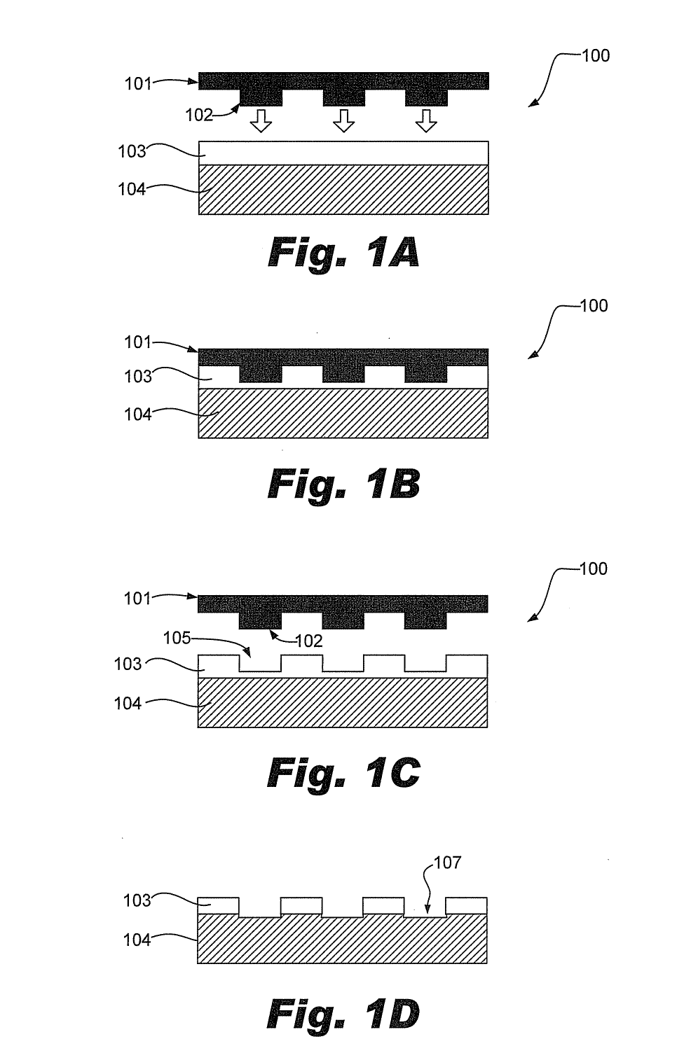

Referring now to FIGS. 1A-1D, cross-sectional diagrams of consecutive steps in an illustrative imprint lithography process are shown. The imprint lithography system (100) includes an imprint lithography stamp (101) that has a functional layer of protruding lithography features (102). The protruding lithography features (102) inversely correspond to desired features in a final circuit to be fabricated on a substrate (104). For example, in the system (100) shown, the protruding lithography features (102) in the imprint lithography stamp (101) correspond to desired grooves or pits to be fabricated in the substrate (104) upon completion of the lithography process. In various embodiments, the substrate (104) may be a semiconductor substrate, a glass substrate, a metal or plastic sheet or a metalized plastic sheet, for example.

The imprint lithography stamp (101), also referred to as a mould, is made out of a hard, durable material. By way of example, materials that may be used for the imprint lithography stamp (101) include, but are not limited to, silicon, other semiconductors, silicon dioxide, silicon carbide, silicon nitride, sapphire, metals, metal alloys, polymeric materials, and combinations thereof.

As noted, the substrate (104) in the imprint lithography system (100) has a layer of resin material (103) deposited thereon. The type of resin used in the layer (103) may depend on the type of imprint lithography for which the system (100) is designed. For example, in embodiments where the system (100) is configured for use in thermal imprint lithography, the resin in the resin layer (103) may be a thermal plastic polymer having a defined melting point, or glass transition temperature, at which the polymer structure becomes decrystallized and substantially elastic. In other embodiments, such as those using ultraviolet imprint lithography, the resin material (103) may be a pliable, photo-sensitive monomer that is cured or crystallized by exposure to a certain frequency of radiation, typically ultraviolet light.

As shown in FIG. 1A, the imprint lithography stamp (101) is disposed above the substrate (104) and its corresponding layer of resin material (103). A downward force is then exerted on the imprint lithography stamp (101) to emboss the resin material (103) with the pattern defined by the protruding features (102) in the functional layer of the imprint lithography stamp (101). This force is illustrated with arrows in FIG. 1A.

FIG. 1B illustrates the result in which the downward force applied in FIG. 1A presses the imprint lithography stamp (101) into the layer of resin material (103) on the substrate (104). During this step, the layer of resin material (103) is in a substantially moldable or elastic state. As noted above, in some embodiments, this is accomplished by heating the layer of resin material (103) to or near the melting point, or glass transition temperature, of a thermal plastic polymer component of the resin material (103). In other embodiments, the layer of resin material (103) is in a substantially moldable or elastic state until it is cured by ultraviolet or other light.

When the imprint lithography stamp (101) is pressed into the layer of resin material (103) on the substrate (104), the resin material in the layer of resin material (103) is deformed according to the shape of the imprint lithography stamp (101). Some portions of the layer of resin material (103) are deformed more than others, thus creating a thickness contrast within the layer of resin material (103). This thickness contrast corresponds to the protruding features (102) of the functional layer of the imprint lithography stamp (101). As noted above, compressed portions of the resin layer (103) where a protruding feature (102) of the stamp (101) has been applied are referred to as a compressed layer.

As shown in FIG. 1C, once the imprint lithography stamp (101) is removed from the layer of resin material (103), the thickness contrast formed in the pattern embossed in the layer of resin material (103) by the downward pressure of the imprint lithography stamp (101) effectively creates an inverse of the features (102) of the imprint lithography stamp (101) in the layer of resin material (103). In the present example, grooves (105) are created in the layer of resin material (103) beneath the protruding features (102) of the imprint lithography stamp (101). The displaced and flattened resin beneath each of these grooves (105) is a compressed layer of resin material.

As shown in FIG. 1D, the compressed layers in the grooves (105, FIG. 1C) of resin material (103) is then selectively etched to expose the substrate (104) under the protruding imprint features (102, FIG. 1C). In some embodiments of imprint lithography, further etching of the exposed substrate (104) material transfers the thickness contrast in the layer of resin material (103) to the substrate (104). Resulting grooves (107) in the substrate (104) may then be used for forming circuit features in the substrate (104) as the substrate (104) is processed further.

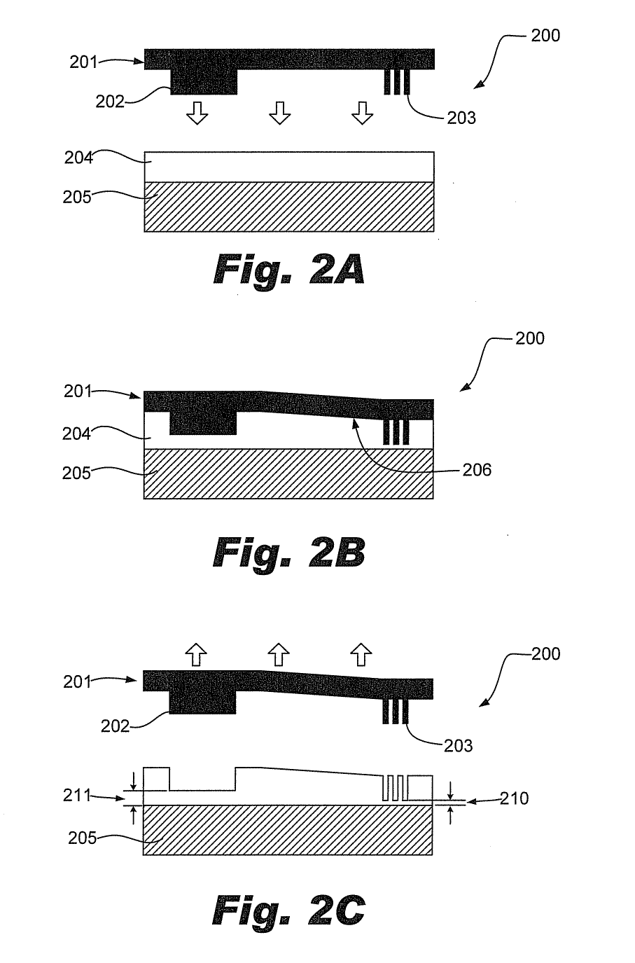

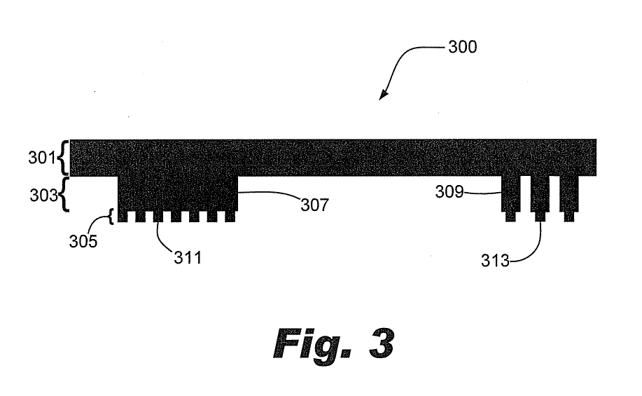

Referring now to FIGS. 2A-2C, cross-sectional views of consecutive steps in an illustrative imprint lithography process are shown, where the imprint lithography system (200) includes an imprint lithography stamp (201) having protruding lithography features (202, 203). In contrast with the uniform protruding features (102, FIG. 1) of the stamp (101, FIG. 1) in the imprint lithography system (100, FIG. 1) described above, the protruding features (202, 203) of the imprint lithography stamp (201) are of more than one size scale. For example, the imprint lithography stamp (201) of the present example includes at least one large-scale protruding feature (202) and several smaller-scale protruding features (203).

As shown in FIG. 2A, the imprint lithography stamp (201) having the irregular protruding lithography features (202, 203) is disposed above a substrate (205) having a layer of resin material (204) deposited thereon. A downward force is exerted on the imprint lithography stamp (201), as indicated by the arrows. FIG. 2B shows how the downward force applied in FIG. 2A is used to press the imprint lithography stamp (201) into the layer of resin material (204) on the substrate (205).

In the system described above with respect to FIG. 1, the imprint lithography stamp (101, FIG. 1) created uniform features, e.g., grooves (105, FIG. 1), in the layer of resin material (103) due to the fact that the substantially uniform protruding features (102, FIG. 1) on the stamp (101) displaced substantially equal amounts of resin material. Conversely, the size discrepancy of the protruding features (202, 203) of the imprint lithography stamp (201) in the present example results in an uneven displacement of resin material by the large- and small-scale features (202, 203). The degree to which this uneven displacement is experienced may be influenced by many factors, including, but not limited to, the relative sizes of the features (202, 203), the amount of resin material in the layer (204), the viscosity of the resin material, and the temperature of the system (200) during imprint.

As noted above, this uneven displacement of resin results in compressed layers of different thickness as between large and small scale imprint features. This difference in compressed layer thickness can also result in a bending of the stamp (201) and a non-horizontal stamp-resin interface (206), shown in FIG. 2B, caused by the uneven displacement of resin material during the imprint process.

As shown in FIG. 2C, when the imprint lithography stamp (201) having differently-sized or differently-scaled protruding features (202, 203) is removed from the layer of resin material (204), a discrepancy exists between the compressed layer thicknesses (211, 210) in the resin material caused by the larger feature (202) and the smaller features (203), respectively. Due to this non-uniform thickness in the compressed layers, it may be difficult to determine the right amount of etching required to etch through the compressed layers of the resin material (204). Consequently, uneven etching may be experienced in the substrate (205) because the compressed layers will take different amounts of etching to expose the underlying substrate material (205).

To address these issues, an illustrative imprint lithography stamp (300) is shown in FIG. 3 according to the principles disclosed in this specification. The illustrative imprint lithography stamp (300) is fabricated out of a hard, durable material such as a material selected from the group consisting of: silicon, other semiconductors, silicon dioxide, silicon carbide, silicon nitride, sapphire, metals, metal alloys, polymeric materials, and combinations thereof.

The illustrative imprint lithography stamp (300), shown here in a cross-sectional side view, is divided into three layers: a base layer (301), a functional layer (303) and a support layer (305). The base layer (301) of the illustrative imprint lithography stamp (300) gives support and structure to the stamp (300). The functional layer (303) includes lithography features (307, 309) that protrude from the base layer (301). The lithography features (307, 309) correspond to a pattern of desired circuit features for fabrication in a substrate of an imprint lithography system utilizing the stamp (300).

The lithography features (307, 309) protruding from the base layer (301) may be of different sizes and shapes, according to the desired features for fabrication in the substrate. In various embodiments for various applications, the stamp (300) may include both large and small-scale features. For example, a large-scale lithography feature (307) may correspond to a desired contact pad well in a substrate, while smaller-scale lithography features (309) may correspond to wells to form conductive traces for the purpose of signal routing.

The support layer (305) includes a regular pattern of sub-features (311, 313) protruding from the lithography features (307, 309) of the functional layer (303). In the illustrated embodiment, the sub-features (311, 313) are all of a substantially uniform size and thickness and protrude only from the lithography features (307, 309) and not from other portions of the base layer (301).

The sub-features create a resin flow pass that avoids the trapping of air bubbles when the illustrative stamp (300) is pressed into a layer of resin material during an imprint lithography process. This resin flow pass allows the varying amounts of resin material displaced by the differently-sized lithography features (311, 313) to be more evenly redistributed such that the thicknesses of resultant compressed layers in the resin material are substantially uniform. With more uniform compressed layers in the resin material, the subsequent etching step in the imprint lithography process may be more effective at producing a pattern in the substrate having the desired depths and thicknesses.

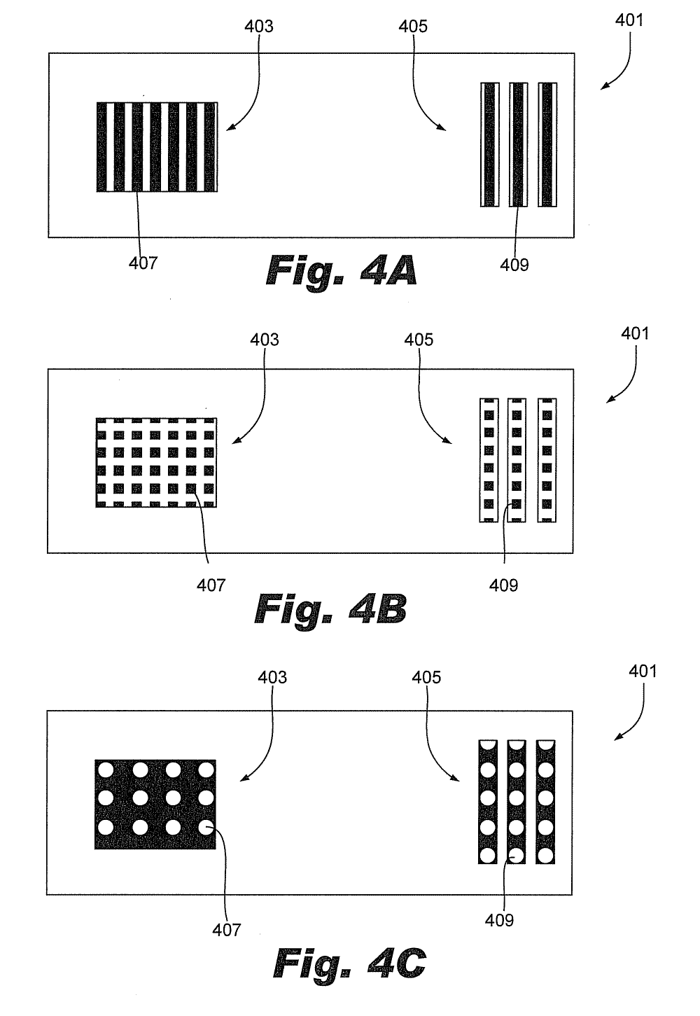

Referring now to FIGS. 4A-4C, bottom views are shown of three different illustrative embodiments of possible imprint lithography stamps (401) according to the configuration described in FIG. 3. Each of the lithography stamps (401) has a base layer (301, FIG. 3), from which lithography features (403, 405) protrude. Substantially uniform sub-features (407, 409) protrude from each of the lithography features (403, 405).

FIG. 4A illustrates an embodiment in which the sub-features (407, 409) are substantially linear. FIG. 4B illustrates an embodiment in which the sub-features (407, 409) are substantially rectangular in cross section. FIG. 4C illustrates an embodiment in which the sub-features (407, 409) are substantially circular in cross section. It is to be understood that many other possible shapes and sizes of sub-features (407, 409) are conceived for use with imprint lithography stamps (401) according to the present specification. With reference to cross-sectional shape, sub-features (407, 409) shapes may include, but are not limited to, circular sub-features, polygonal sub-features, linear sub-features, and combinations thereof.

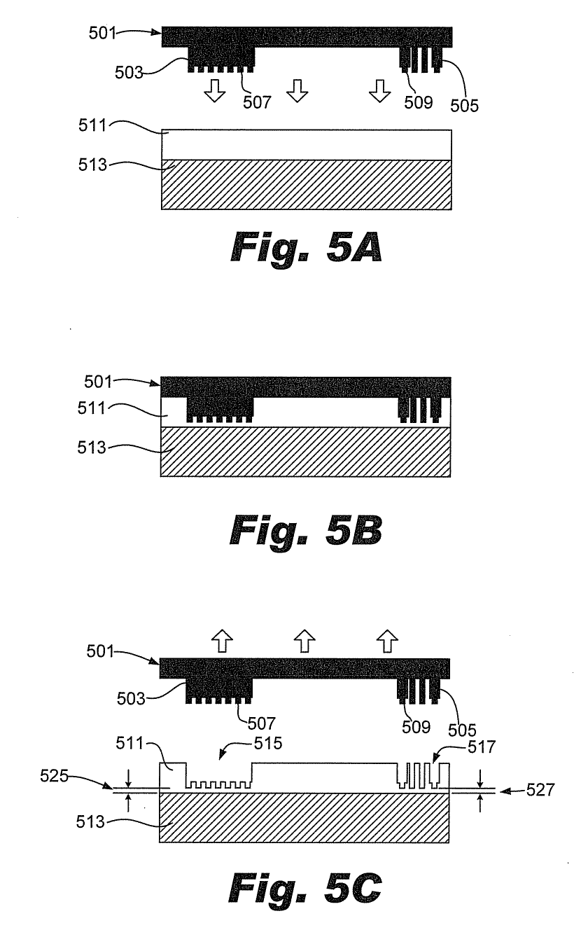

Referring now to FIGS. 5A-5C, consecutive steps of an illustrative imprint lithography process are shown using an imprint lithography stamp (501) having uniform sub-features (507, 509) protruding from the lithography features (503, 505), according to principles disclosed herein. FIG. 5A shows the exertion of a downward force (indicated by the arrows) of the imprint lithography stamp (501) into a layer of resin material (511) deposited on a substrate (513).

As shown in FIG. 5B, the downward force applied in FIG. 5B is used to press the imprint lithography stamp (501) into the layer of resin material (511) on the substrate (513). As shown in FIG. 5C, upon removal of the imprint lithography stamp (501) from the layer of resin material (511) on the substrate (513), a pattern of imprints (515, 517) of the lithography features (503, 505) and the sub-features (507, 509) are left in the layer of resin material (511). Due to the improved resin flow during the imprinting process that is provided by the sub-features (507, 509), the imprints (515, 517) have resultant compressed layers of substantially uniform thickness (525, 527) regardless of the discrepancy in size or scale of the lithography features (503, 505).

Consequently, the substantially uniform compressed layers in the resin material make the subsequent etching step in the imprint lithography process more effective at producing a desired pattern in the substrate (513) having the intended depths and thicknesses. Thus, the desired features or circuit elements based on the lithography can be more reliable formed on the substrate (513).

Having described an illustrative method of using an imprint lithography stamp with lithography features and corresponding sub-features for creating uniform resin compressed layers, the specification will now describe an illustrative method of forming the imprint lithography stamp itself. As noted above, an illustrative imprint lithography stamp is fabricated out of a hard, durable material, for example, silicon, other semiconductors, silicon dioxide, silicon carbide, silicon nitride, sapphire, metals, metal alloys, polymeric materials, and combinations thereof. In the illustrated example, a semiconductor substrate will be described in the production of the lithography stamp with the understanding that other materials may be used as described herein.

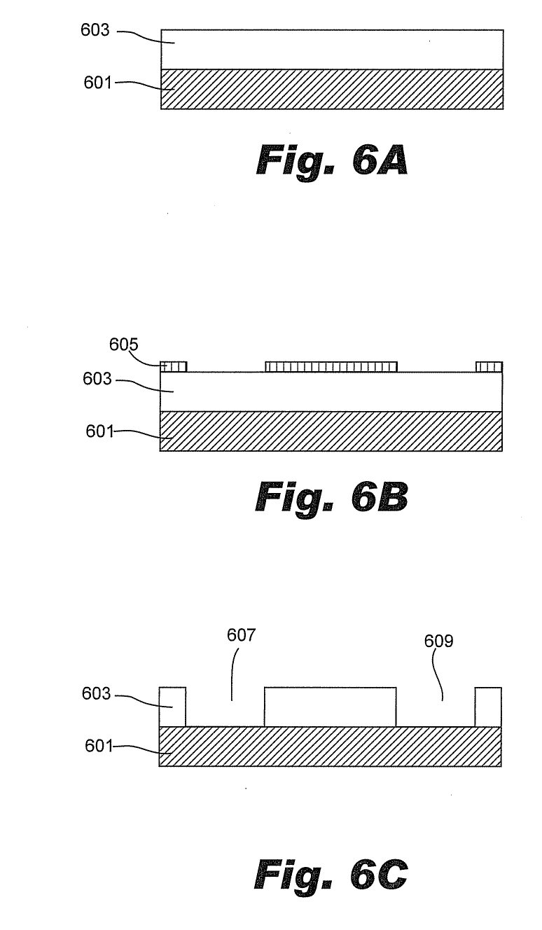

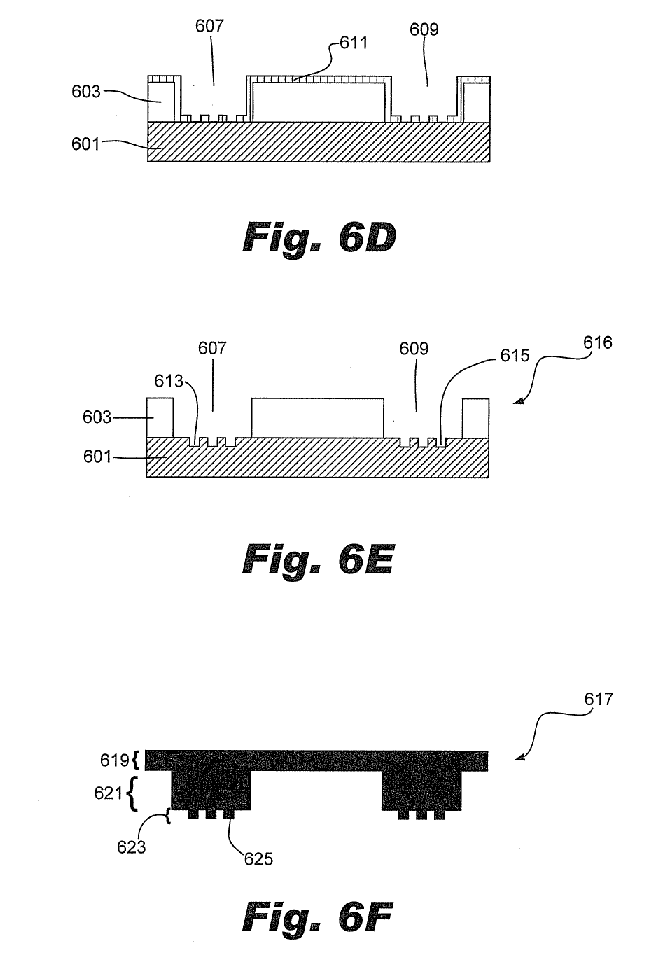

Referring now to FIGS. 6A-6F, consecutive steps are shown in an illustrative process for fabricating an imprint lithography stamp with sub-features as described above. As shown in FIG. 6A, the first step in the illustrative process involves providing a semiconductor substrate (601) having an oxide layer (603) grown thereon. As shown in FIG. 6B, a layer of photoresist (605) is applied to the oxide layer (603) and selectively patterned according to desired lithography features in the imprint lithography stamp.

As shown in FIG. 6C, the oxide layer (603) is etched and the remaining photoresist material from the photoresist layer (605) is stripped. This leaves voids (607, 609) in the oxide layer (603) of the semiconductor substrate (601) that are an inverse pattern of the desired lithography features. As shown in FIG. 6D, another layer of photoresist (611) is then applied to the semiconductor substrate (601) and oxide layer (603). The layer of photoresist (611) is then patterned according to desired sub-features in a support layer of the imprint lithography stamp.

As shown in FIG. 6E, the semiconductor substrate (601) is then selectively etched through the developed photoresist layer (611) such that the regular pattern of sub-features (613, 615) is provided in the voids (607, 609). The remaining photoresist is stripped, and a template structure (616) is produced.

Finally, the template structure (616) shown in FIG. 6E is then used as a mold or form to farm the desired imprint lithography stamp (617). As described above, the imprint lithography stamp (617) has a base layer (619), a functional layer (621) and a support layer (623) with lithography sub-features. In the illustrated embodiment, the resultant sub-features (625) in the support layer (623) have a substantially uniform shape and size.

The template structure (616) may be used and the stamp (617) completed by depositing a stamp material over the structure (616) and then selectively removing the template structure (616). In some embodiments, the template structure may be destructively removed. However, in other embodiments, the template structure may be kept for future imprint lithography stamp fabrication.

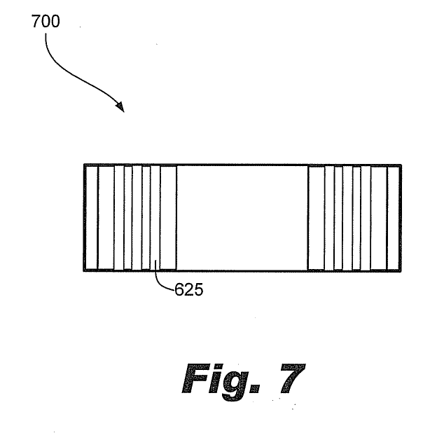

Referring now to FIG. 7, a bottom view of the illustrative imprint lithography stamp (617) produced by the process described in FIGS. 6A-6F is shown. In the present example, the sub-features (625) of the support layer (623, FIG. 6) are linear. However, other shapes and sizes of sub-features (625) may be created using the process described in FIGS. 6A-6F.

### Exemplary Methods

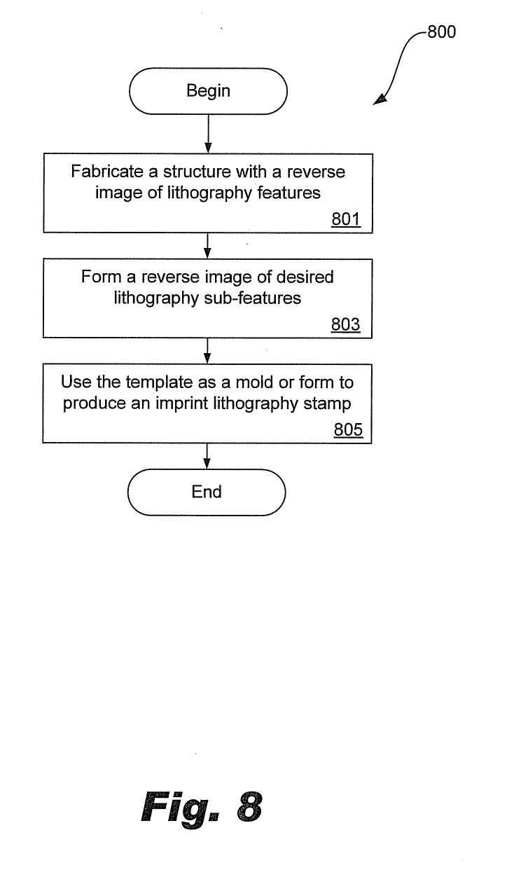

Referring now to FIG. 8, a flowchart is shown of an illustrative method (800) of fabricating an imprint lithography stamp with lithography features and corresponding sub-features. The method (800) includes fabricating (step 801) a structure with a reverse image of a desired pattern of lithography features in a template substrate. This may be accomplished by selectively etching the template substrate.

A regular pattern of sub-features is then provided (step 803) within the template structure of the desired lithography features. These sub-features are in a reverse image of the sub-features to be formed on the lithography stamp being fabricated. Again, this step may be accomplished by selectively etching the portions of the template substrate corresponding to the structure of the desired lithography features. In some embodiments, with reference to cross section shape, the sub-features may be selected from the group consisting of circular sub-features, polygonal sub-features, linear sub-features, and combinations thereof.

The resultant geometry of the template substrate is then used as a mold or form (step 805) to produce the imprint lithography stamp. This may be accomplished, for example, by depositing a stamp material over the template substrate and selectively removing the template substrate and its associated structures.

The preceding description has been presented only to illustrate and describe embodiments and examples of the principles described. This description is not intended to be exhaustive or to limit these principles to any precise form disclosed. Many modifications and variations are possible in light of the above teaching. What is claimed is:

1. An imprint lithography stamp (101, 201, 401, 501, 617), said stamp (101, 201, 401, 501, 617) comprising:
a base layer (301, 619);
a functional layer (303, 621) of lithography features 307, 309, 403, 405, 503, 505) protruding from said base layer (301, 619); and
a support layer (305, 623) comprising a regular pattern of sub-features (311, 313, 407, 409, 507, 509, 613, 615, 625) protruding from said lithography features (307, 309, 403, 405, 503, 505).

2. The imprint lithography stamp (101, 201, 401, 501, 617) of claim 1, wherein said stamp (101, 201, 401, 501, 617) is fabricated out of a material selected from the group consisting of: silicon, other semiconductors, silicon dioxide, silicon carbide, silicon nitride, sapphire, metals, metal alloys, polymeric materials, and combinations thereof.

3. The imprint lithography stamp (101, 201, 401, 501, 617) of claim 1, wherein said stamp (101, 201, 401, 501, 617) is configured for use with a lithography process selected from the group of ultraviolet imprinting, thermal imprinting, and combinations thereof.

4. The imprint lithography stamp (101, 201, 401, 501, 617) of claim 1, wherein said lithography features (307, 309, 403, 405, 503, 505) correspond to desired circuit features for fabrication in a semiconductor substrate (104, 205, 513, 601).

5. The imprint lithography stamp (101, 201, 401, 501, 617) of claim 1, wherein said sub-features (311, 313, 407, 409, 507, 509, 613, 615, 625) comprise an array of protrusions extending from said lithography features (307, 309, 403, 405, 503, 505).

6. The imprint lithography stamp (101, 201, 401, 501, 617) of claim 5, wherein each of said sub-features (311, 313, 407, 409, 507, 509, 613, 615, 625) extends a substantially uniform length from said lithography features (307, 309, 403, 405, 503, 505).

7. The imprint lithography stamp (101, 201, 401, 501, 617) of claim 1, wherein said sub-features (311, 313, 407, 409, 507, 509, 613, 615, 625) have a cross-sectional shape selected from the group consisting of: circular, polygonal, linear and combinations thereof.

8. The imprint lithography stamp (101, 201, 401, 501, 617) of claim 1, wherein said support layer (305, 623) is configured to produce compressed layers having a substantially uniform thickness (210, 211, 525, 527) when said stamp (101, 201, 401, 501, 617) is pressed into a layer of resin (511) on a lithography substrate (104, 205, 513, 601).

9. An imprint lithography system (100, 200, 300), said system (100, 200, 300) comprising:
a substrate (104, 205, 513, 601) having a layer of resin material (511) deposited thereon;
a stamp (101, 201, 401, 501, 617) having a base layer (301, 619), a functional layer (303, 621) of lithography features (307, 309, 403, 405, 503, 505) protruding from said base layer (301, 619) and a support layer (305, 623) comprising a regular pattern of sub-features (311, 313, 407, 409, 507, 509, 613, 615, 625) protruding from said lithography features (307, 309, 403, 405, 503, 505); and
an imprinting device configured to press said stamp (101, 201, 401, 501, 617) into said resin material (511).

10. The imprint lithography system (100, 200, 300) of claim 9, wherein said substrate (104, 205, 513, 601) comprises any of a glass substrate (104, 205, 513, 601), plastic sheet, metal sheet, metalized plastic sheet or semiconductor wafer.

11. The imprint lithography system (100, 200, 300) of claim 9, wherein said resin material (511) comprises a resin (511) selected from the group consisting of: thermal plastic polymers, photopolymers, curable monomers and combinations thereof.

12. The imprint lithography system (100, 200, 300) of claim 9, wherein said lithography features (307, 309, 403, 405, 503, 505) correspond to desired circuit features for fabrication in said substrate (104, 205, 513, 601).

13. The imprint lithography system (100, 200, 300) of claim 9, wherein said sub-features (311, 313, 407, 409, 507, 509, 613, 615, 625) have a cross-sectional shape selected from the group consisting of: circular, polygonal, linear and combinations thereof.

14. The imprint lithography system (100, 200, 300) of claim 13, wherein each of said sub-features (311, 313, 407, 409, 507, 509, 613, 615, 625) extends a substantially uniform distance from a corresponding lithography feature (307, 309, 403, 405, 503, 505).

15. The imprint lithography system (100, 200, 300) of claim 9, wherein said support layer (305, 623) is configured to produce compressed layers having a substantially uniform thickness (210, 211, 525, 527) when said stamp (101, 201, 401, 501, 617) is pressed into said layer of resin (511) on said substrate (104, 205, 513, 601).

16. A method of fabricating an imprint lithography stamp (101, 201, 401, 501, 617), said method comprising:
forming a reverse image of desired lithography features (307, 309, 403, 405, 503, 505) in a template substrate (104, 205, 513, 601);
forming a regular pattern of lithography sub-features (311, 313, 407, 409, 507, 509, 613, 615, 625) in said desired lithography features (307, 309, 403, 405, 503, 505) of said inverse structure; and
using said template structure to form said imprint lithography stamp (101, 201, 401, 501, 617).

17. The method of claim 16, wherein said forming a reverse image of desired lithography features (307, 309, 403, 405, 503, 505) in said substrate (104, 205, 513, 601) further comprises selectively etching said substrate (104, 205, 513, 601).

18. The method of claim 17, wherein said forming a regular pattern of lithography sub-features (311, 313, 407, 409, 507, 509, 613, 615, 625) in said desired lithography features (307, 309, 403, 405, 503, 505) comprises selectively etching a reverse image of said lithography sub-features (311, 313, 407, 409, 507, 509, 613, 615, 625) into said lithography features (307, 309, 403, 405, 503, 505).

19. The method of claim 16, wherein said sub-features (311, 313, 407, 409, 507, 509, 613, 615, 625) have a cross-sectional shape selected from the group consisting of: circular, polygonal, linear and combinations thereof.

20. The method of claim 16, wherein said using said template structure to form said imprint lithography stamp (101, 201, 401, 501, 617) comprises depositing a layer of stamp material over said template structure and removing said template structure.
